(19) United States
(12) Patent Application Publication
(10) Pub. No.: US 2025/0106690 A1
(43) Pub. Date: Mar. 27, 2025

(54) METHODS AND SYSTEM OF COLLABORATIVE LINK ADAPTATION

(71) Applicants: HUAWEI TECHNOLOGIES CANADA CO., LTD., Kanata (CA); THE UNIVERSITY OF WESTERN ONTARIO, London (CA)

(72) Inventors: Jiyang BAI, London (CA); Xianbin WANG, London (CA); Yan XIN, Kanata (CA); Jung Hoon SUH, Kanata (CA); Osama ABOUL-MAGD, Kanata (CA); Kwok Shum AU, Kanata (CA)

(73) Assignees: HUAWEI TECHNOLOGIES CANADA CO., LTD., Kanata (CA); THE UNIVERSITY OF WESTERN ONTARIO, London (CA)

(21) Appl. No.: 18/372,419

(22) Filed: Sep. 25, 2023

(51) Int. Cl. H04W 28/08; H04W 28/086

(52) U.S. Cl. CPC H04W 28/0958; H04W 28/0864

(57) ABSTRACT

Methods, apparatus, and systems are disclosed for collaborative link adaptation between an access point and stations of a wireless network. In embodiments of the present disclosure, the problem of optimizing network links may be distributed from the access point to the stations, which may each determine whether they should locally solve the problem of optimizing their respective link to the access point or should return the optimization problem to the access point. The access point may optimize the links to stations that do not solve the optimization problem themselves. Embodiments may evaluate the transmission performance and computational costs of each station and of the network in determining where optimization should be done.

### CROSS-REFERENCE TO RELATED APPLICATIONS

This is the first application filed for the present invention.

### FIELD OF THE INVENTION

The present invention pertains to communication networks and in particular to methods, apparatus, and systems for link adaptation.

### BACKGROUND

Link adaptation (LA) is a technique used to improve the reliability of wireless local area networks (WLANs) such as Wi-Fi networks. By modifying parameters in the physical (PHY) layers and medium access control (MAC) layers of a network, LA aims to improve the throughput, latency, jitter, and efficiency of communication channels in the network as changes occur in the channel conditions. Modifications can, for example, be made to the modulation and coding scheme (MCS), resource unit (RU) allocation, spatial streams, or channel bandwidth. As a technique with crossover between the PHY and MAC layers, LA requires real-time mechanisms to handle the dynamics of channel conditions. With WLANs increasingly supporting more device connections in increasingly diverse and heterogeneous application scenarios, real-time adaptation is becoming increasingly difficult. Optimizing LA, as a mixed-integer nonlinear programming problem, can be nonlinear programming hard and so may be unlikely to yield a solution within reasonable processing time for large-scale networks, thereby preventing real-time operation.

To facilitate adjustments by LA, technologies of the prior art have either adopted centralized optimization strategies or have taken distributed approaches that use task-offloading methods to reduce the size of the optimization problem. Centralized optimization faces high problem complexity in large-scale networks, which means results cannot be processed in a timely manner, even if the optimization is separated into several subproblems. In some centralized approaches, an artificial intelligence (AI) model may be used to predict future channel conditions to reduce the difficulty of LA adjustments and reinforcement learning may be used to reduce the optimization time within each LA adjustment. However, these models are still challenged by exponentially rising state and action spaces of the LA optimization problem in large networks. These factors cause high training costs and make timely updates to the AI models unfeasible. Alternatively, distributed approaches utilize the processing capacity across the network to solve the optimization problem. However, distributing an AI model would incur high training costs and require all network devices to operate the AI model. Thus, neither centralized nor distributed approaches can meet the demands for LA optimization in large-scale networks.

Therefore, there is a need for methods, apparatus, and systems for LA optimization.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide methods, apparatus, and systems for LA optimization.

A first aspect of the present disclosure provides a method for LA in a network system including an access point (AP) coupled to one or more stations (STAs) through a respective one or more links. Each STA may be configured to determine a respective set of optimal link (OL) parameters. Each STA may have a respective STA transmission performance metric characterizing at least one data transmission parameter of the respective STA for the respective link, and a respective STA utility metric characterizing at least one data processing parameter of the respective STA. The network system may have a system performance metric characterizing an average performance for transmitting data in the network system. The method may comprise, by the AP: obtaining, from each STA, a respective set of LA parameters, the respective set of LA parameters including, when the respective STA utility metric is greater than the system performance metric, the respective set of OL parameters; and determining, for each STA from which the respective set of LA parameters lacks the respective set of OL parameters, the respective set of OL parameters.

In some embodiments of the first aspect, the method may further comprise, by the AP, for at least one STA of the one or more STAs, in accordance with the respective set of OL parameters, at least one of: sending data thereto through the respective link and receiving data therefrom through the respective link. In some embodiments, the method may further comprise, by the AP, determining the system performance metric. In some embodiments, the method may further comprise, by the AP, sending, to each STA, the system performance metric and a respective transmission power allocation. In some of these embodiments, sending, to each STA, the system performance metric and the respective transmission power allocation may include sending a frame having a high throughput (HT) control field, the HT control field including a plurality of subfields indicating the respective transmission power allocation and the system performance metric. In some embodiments, the method may further comprise, by the AP, applying, for the at least one STA of the one or more STAs, the set of OL parameters to the respective link.

In some embodiments of the first aspect, each STA may further have, for determining the respective set of OL parameters, a respective processing time and a respective time limit. In these embodiments, the respective set of LA parameters obtained from each STA by the AP may include the respective set of OL parameters when the respective STA utility metric is greater than the system performance metric and when the respective processing time is less than the respective time limit.

In some embodiments of the first aspect, the respective STA transmission performance metric for each STA may be defined by a respective STA transmission performance function. In some embodiments, the system performance metric may be defined by a system performance function depending from an average of the respective STA transmission performance function for all STAs of the one or more STAs. In other embodiments, the system performance metric may be defined by a system performance function defined by an average of the respective STA transmission performance function for all STAs from which the respective set of OL parameters lacks the respective set of OL parameters. In some of these embodiments, determining, for each STA from which the respective set of LA parameters lacks the respective set of OL parameters, the respective set of OL parameters may include maximizing the system performance function. In some embodiments, each STA may be configured to determine the respective set of OL parameters by maximizing the respective STA transmission performance function. In some embodiments, the respective STA transmission performance function of each STA may depend from a respective weighted sum of a respective data rate provisioning index and a respective packet error rate provisioning index. In some of these embodiments, the respective data rate provisioning index and the respective packet error rate provisioning index may each depend from a respective transmission power allocation. In some embodiments, the STA transmission performance function may be defined by the respective STA transmission performance function and a respective STA cost transformation. In some embodiments, the respective STA cost transformation of at least one STA may be a subtraction of a respective computing cost. In some embodiments, the respective STA cost transformation of at least one STA may be a multiplication by a respective cost factor. In some embodiments, the respective STA cost transformation of at least one STA may be an identity transformation.

In some embodiments of the first aspect, the AP may include an AP controller. In some embodiments, at least one STA of the one or more STAs may include a STA controller.

In some embodiments of the first aspect, obtaining, from each STA, the respective set of LA parameters may include obtaining, from each STA of which the LA parameters lacks the respective set of OL parameters, a respective signal-to-interference-plus-noise ratio and one or more respective quality-of-service requirements.

In some embodiments of the first aspect, obtaining, from each STA, the respective set of LA parameters includes obtaining a frame having a high throughput (HT) control field indicating the set of LA parameters. In some embodiments, for each STA from which the respective set of LA parameters lacks the respective set of OL parameters, the HT control field may have a plurality of subfields indicating a signal-to-interference-plus-noise ratio and one or more respective quality-of-service requirements.

In some embodiments of the first aspect, the network may be a wireless local area network. In some of these embodiments, the wireless local area network may be a Wi-Fi network. In some embodiments, at least one STA may be one of a user equipment and an internet-of-things device.

In some embodiments of the first aspect, at least one set of OL parameters may include one of: a plurality of parameters for a modulation and coding scheme, and a plurality of parameters for a resource unit allocation.

A second aspect of the present disclosure is to provide a network system comprising one or more STAs coupled to an AP through a respective one or more links. Each STA may be configured to determine a respective set of OL parameters. Each STA may have a respective STA transmission performance metric characterizing at least one data transmission parameter of the respective STA for the respective link, and a respective STA utility metric characterizing at least one data processing parameter of the respective STA. The network system may have a system performance metric characterizing an average performance for transmitting data in the network system. The AP may be configured to: obtain, from each STA, a respective set of link adaptation (LA) parameters, the respective set of LA parameters including, when the respective STA utility metric is greater than the system performance metric, the respective set of OL parameters; and determine, for each STA from which the respective set of LA parameters lacks the respective set of OL parameters, the respective set of OL parameters.

A third aspect of the present disclosure is to provide an electronic device comprising a processor coupled to tangible, non-transitory processor-readable memory, the memory having stored thereon instructions to be executed by the processor to implement the method of the first aspect or any embodied variations thereof.

A fourth aspect of the present disclosure is to provide a non-transitory processor-readable memory having stored thereon instructions to be executed by a processor to implement the method of the first aspect or any embodied variations thereof.

A fifth aspect of the present disclosure is to provide a computer program comprising instructions to be executed by a computer to implement the method of the first aspect or any embodied variations thereof.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 shows a typical wireless network where embodiments according to the present disclosure may be implemented.

FIG. 2A shows a flowchart of a method for LA by an access point of a network, according to an embodiment of the present disclosure.

FIG. 2B shows a flowchart of a method for LA by one or more stations of network, according to an embodiment of the present disclosure.

FIG. 3 shows a high throughput control field that may be used to implement at least part of embodiments of the present disclosure.

FIG. 4 shows an example implementation of a method of the present disclosure towards downlink transmission in a network.

FIG. 5 shows an example of frames sent between an access point and a station of a network in implementing a method of the present disclosure.

FIG. 6 shows an apparatus for LA, according to embodiments of the present disclosure.

FIG. 7 shows a schematic of an embodiment of an electronic device that may implement at least part of the methods and features of the present disclosure.

It will be noted that throughout the appended drawings, like features are identified by like reference numerals.

### DETAILED DESCRIPTION

To improve LA, embodiments of the present disclosure are generally directed towards optimizing transmission parameters of links between network stations (STAs) and a network access point (AP) collaboratively. In some embodiments, the computing capacity and transmission performance of each station, and averages thereof for multiple stations, may determine whether a STA optimizes its respective link to the AP. In some embodiments, the AP may support some STAs by optimizing their respective links. In some further embodiments, data may be transmitted between the AP and a STA in accordance with parameters determined from collaboratively optimizing the respective link.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. The terms in each of the following sets may be used interchangeably throughout the disclosure: “computing capacity”, “utility”, “utility metric”, “local utility index”; and “utility function” and “performance function”.

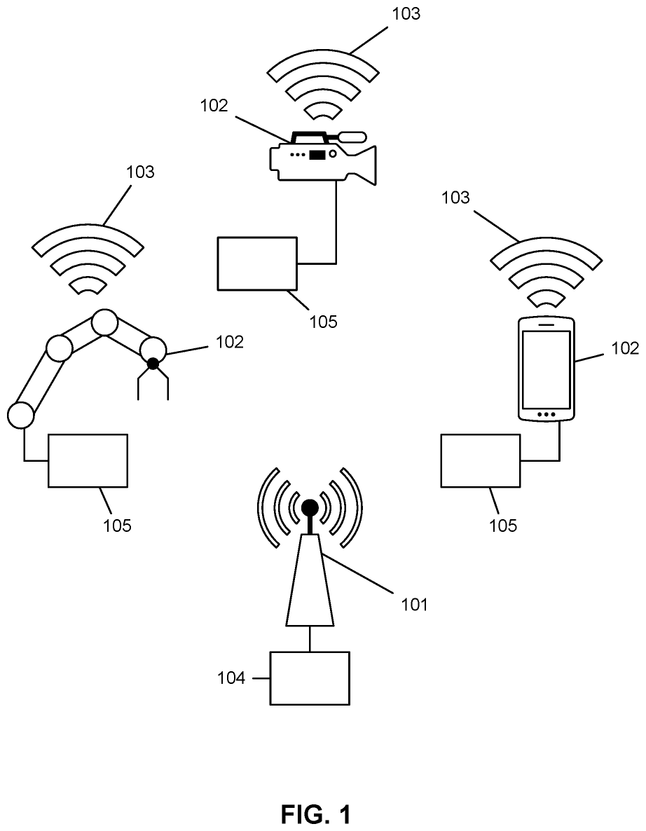

FIG. 1 shows a typical wireless network (i.e., a “network system”) where LA according to embodiments of the present disclosure may be implemented. An AP 101 is connected to one or more STAs 102 through a respective one or more wireless links 103 through which data may be transmitted. The AP 101 may have an AP controller 104 associated with it, each STA 102 may have a STA controller 105 associated with it. The wireless network may, for example, be a WLAN such as a Wi-Fi network. The wireless network may further be a radiowave cellular network or Bluetooth network. Each STA 102 may, for example, be a user equipment such as a mobile device, an internet-of-things device, an autonomous vehicle, a personal computer, or a smart watch. The AP 101 may be a network device that connects the STAs 102 to a broader network such as a wired network or the internet. The AP 101 may, for example, be a wireless router. The AP 101 may further, for example, implement the IEEE 802.11 standard. The AP controller 104 and each STA controller 105 may control the respective network device, determining when it may send and/or receive data (i.e., channel access). The AP controller 104 and each STA controller 105 may be remote to or located at, or be part of, the respective network device. LA may, for example, be used in the scenario of FIG. 1 to modify parameters of the PHY or MAC layers of the network, such as in the MCS or RU allocation, in response to changes in the conditions of each link 103.

In embodiments of the present disclosure, the optimization of a link 103 to the AP 101 by the respective STA 102 may have an associated utility (i.e., a “utility metric”) for the respective STA 102. The utility may describe the benefits towards transmission performance and the computational costs of a STA 102 in optimizing its respective link 103. The STA utility, STA_Uₙ^{k}, for the nth STA 102 and for a kth transmission timeslot may be defined by the function:

$${STA\_U}_{n}^{k} = {STA\_T}_{n}^{k - 1} - {STA\_C}_{n}^{k} \qquad ( 1 )$$

where STA_Tₙ^{k-1} is a transmission performance (STA transmission performance metric) for the previous timeslot and STA_Cₙ^{k} is a computing cost (i.e., a “data processing parameter”) for the STA in question. The STA_THE characterizes the data transmission capacity of the STA in a kth timeslot. STA_Tₙ^{k} may have associated thereto a series of different possible values each indicating the amount of data that may be transmitted by the STA.

The STA_Cₙ^{k} characterizes the processing capacity of the STA. STA_Cₙ^{k} may have associated thereto a series of different possible values each indicating the unavailability of resources at the STA to perform processing operations. In some embodiments, the higher the value of STA_Cₙ^{k}, the greater the unavailability.

The transmission performance STA_Tₙ^{k} of the nth STA 102 may be defined by a transmission performance function (i.e., an “STA transmission performance function”) taking the form of a weighed sum of quality-of-service (QOS) parameters:

$${STA\_T}_{n}^{k} = {\sum }_{j = 1}^{J} Q o {S}_{n}^{k} [ j ] * {Weight}_{n}^{k} [ j ] \qquad ( 2 )$$

where QoSₙ^{k}[j] are indices relating to QOS provisioning (i.e., “data transmission parameters”), and Weightₙ^{k}[j] are corresponding weights. In some embodiments, when optimizing the MCS (i.e., a “set of optimal link parameters”) of a link 103 for an upcoming transmission in a kth timeslot, the transmission performance of the nth STA 102 may be defined by two QoS provisioning indices: index QoSₙ^{k}[1], which may relate to data rate (DR) provisioning DRₙ^{k}, and QoSₙ^{k}[2], which may relate to a packet error rate (PER) provisioning PERK. In other embodiments, the transmission performance may be defined by other QoS provisioning indices such as indices related to latency, jitter, localization accuracy, target speed, or environment model. In the case of optimizing the MCS, Equation 2 takes the form:

$${STA\_T}_{n}^{k} = Q o {S}_{n}^{k} [ 1 ] * {Weight}_{n}^{k} [ 1 ] + Q o {S}_{n}^{k} [ 2 ] * {Weight}_{n}^{k} [ 2 ] \qquad ( {2}^{′} )$$

DR provisioning and PER provisioning may each be a function of the MCS and of the transmission power pₙ^{k} allocated to the nth STA 102 for the kth timeslot. The index QoSₙ^{k}[1] for DR provisioning and the index QoSₙ^{k}[2] for PER provisioning may be defined as:

$${QoS}_{n}^{k} [ 1 ] = \{ \begin{matrix}1 , & when {DR}_{n}^{k} ( MCS , {p}_{n}^{k} ) \geq \overline{{DR}_{n}^{k}} \\ 0 , & otherwise\end{matrix} \qquad ( 3 )$$

$$Qo {S}_{n}^{k} [ 2 ] = \{ \begin{matrix}1 , & when {PER}_{n}^{k} ( MCS , {p}_{n}^{k} ) \geq \overline{{PER}_{n}^{k}} \\ 0 , & otherwise\end{matrix} \qquad ( 4 )$$

where D̅R̅ₙ̅^̅{̅k̅}̅ and P̅E̅R̅ₙ̅^̅{̅k̅}̅ are, respectively, the maximum DR requirement and the maximum PER requirement for the nth station at the kth timeslot. The weights Weightₙ^{k}[1] and Weightₙ^{k} [2] of Equation 2 may be normalized to one. The computing cost STA_Cₙ^{k} of Equation 1 may be determined by the processing capacity of the respective STA 102 and may depend on the indices of Equations 3 and 4 as well as the allocated transmission power. For example, a STA 102 with a high processing capability may have a low STA computing cost STA_Cₙ^{k}. In determining utility, the computing cost may be subtracted from the transmission performance STA_Tₙ^{k}, or may, alternatively, be applied as a multiplicative factor or another suitable mathematical transformation. In some embodiments, the mathematical transformation may be an identity transformation, such that the STA utility of Equation 1 equals the transmission performance (i.e., STA_ₙ^{k}=0).

The transmission power pₙ^{k} allocated to the nth STA 102 for the kth timeslot may be limited by a power constraint P associated with the wireless network. The transmission powers allocated to all N STAs 102 may need to be in accordance with:

$${\sum }_{n = 1}^{N} {p}_{n}^{k} \leq P \qquad ( 5 )$$

In some embodiments, the transmission power allocations may be determined through a power control algorithm.

Equations 1 to 4 indicate that the maximum utility of the nth STA 102 at the kth timeslot (STA_Uₙ^{k}) may occur when the STA 102 can provide transmission performance at or beyond the relevant QoS requirements, per Equations 3 and 4, and when the computing costs of the STA 102 are minimized. Equations 1 to 4 further indicate that the utility of a STA 102 may depend on the transmission power allocated and the MCS through, at least, the data rate provisioning DRₙ^{k} and packet error rate provisioning PERₙ^{k}. A person skilled in the art would understand that data rate provisioning DRₙ^{k} would increase with allocated transmission power and that packet error rate provisioning PERₙ^{k} would decrease with allocated transmission power.

In some embodiments, the wireless network around the AP 101 may have a system performance (i.e., a “system performance metric”) associated with it that describes an average performance for data transmissions through the respective links 103. The system performance SYS_Uₙ^{k} for the kth timeslot for N STAs 102 may be defined by a system performance function:

$${SYS\_U}_{A}^{k} = \frac{1}{N} {\sum }_{n = 1}^{N} {STA\_T}_{n}^{k} = \frac{1}{N} {\sum }_{n = 1}^{N} {\sum }_{j = 1}^{J} Q o {S}_{n}^{k} [ j ] * {Weight}_{n}^{k} [ j ] \qquad ( 6 )$$

$${SYS\_U}_{A}^{k} = \frac{1}{N} {\sum }_{n = 1}^{N} {STA\_T}_{n}^{k} = \frac{1}{N} {\sum }_{n = 1}^{N} ( Q o {S}_{n}^{k} [ 1 ] * {Weight}_{n}^{k} [ 1 ] + {QoS}_{n}^{k} [ 2 ] * {Weight}_{n}^{k} [ 2 ] ) \qquad ( {6}^{′} )$$

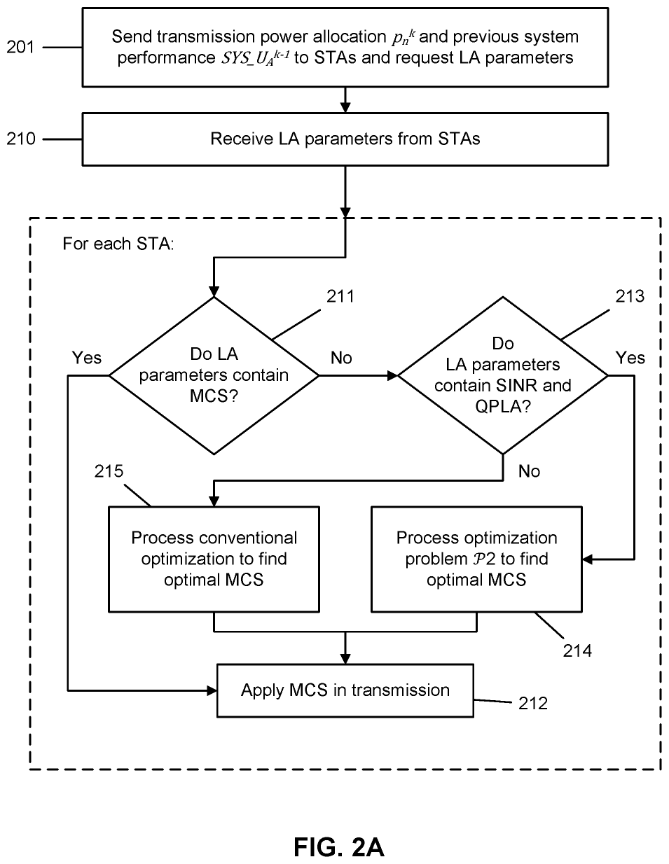

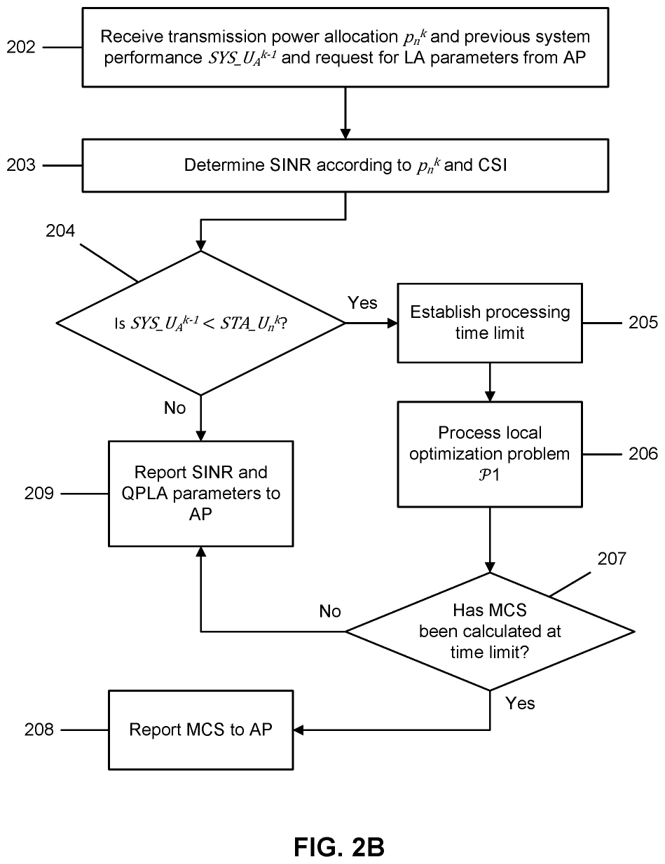

FIG. 2A and FIG. 2B each show a flowchart of part of a method for LA according to an embodiment of the present invention. The method of FIG. 2A and FIG. 2B may be implemented in the wireless network of FIG. 1 and may describe a process for optimizing the links 103 for upcoming data transmissions during a kth timeslot. FIG. 2A shows the actions of an AP 101 (or an AP controller 104) in implementing the method, while FIG. 2B shows the actions of each STA 102 (or STA controller 105) in implementing the method. Beginning in FIG. 2A, at action 201, the AP 101 may send to each STA 102 a request for LA parameters along with a respective STA power allocation pₙ^{k} for upcoming transmissions and the system performance for the previous timeslot SYT_U_{A}^{k-1}. In some embodiments, the respective STA power allocation pₙ^{k} for upcoming transmissions in the kth timeslot that is communicated to the corresponding STA 102 may be the STA power allocation for the previous k-1 timeslot, pₙ^{k-1}; in these cases, the actual transmission power allocated to the STA 102 may be updated at the kth slot and may differ from the value communicated to the STA 102. In FIG. 2B, at action 202, each STA 102 receives the request for LA parameters, the respective power allocation, and the previous system performance. At action 203 of FIG. 2B, each STA 102 may then determine a respective signal-to-interference-plus-noise ratio (SINR) for the respective link 103 (i.e., the strength of the received signal), in accordance with the respective power allocation and channel state information (CSI) obtained by the STA 102. Each STA 102 may use the SINR for the respective link 103 towards calculating the respective data rate provisioning DRₙ^{k} and packet error rate provisioning PERₙ^{k}.

Next, each STA 102 may determine whether it should locally calculate a set of optimal link parameters for the respective link 103 or leave this calculation to the AP 101. The set of optimal link parameters for the respective link 103 between the STA 102 and the AP 101 may modify parameters of the PHY or MAC layers of the network. In the method of FIG. 2A and FIG. 2B, the set of optimal link parameters constitute a new MCS for the respective link 103. In other embodiments, the set of optimal link parameters may include new RU allocations. At action 204 of FIG. 2B, each STA 102 may compare the previous system performance received from the AP 101, SYS_Uₙ^{k-1}, to a respective STA utility, STA_Uₙ^{k}. If the previous system performance is less than the respective STA utility, the STA 102 may elect to calculate the set of optimal link parameters locally. Prior to calculating the respective set of optimal link parameters, each STA 102 may establish a time limit for the calculations, at action 205 of FIG. 2B. At action 206 of FIG. 2B, each STA 102 may begin calculating the respective MCS, by solving the following maximization problem:

$$1 : {max}_{MCS} {STA\_T}_{n}^{k} = {\sum }_{j = 1}^{J} Q o {S}_{n}^{k} [ j ] * {Weight}_{n}^{k} [ j ] \qquad ( 7 )$$

$$1 : {max}_{MCS} {STA\_T}_{n}^{k} = Q o {S}_{n}^{k} [ 1 ] * {Weight}_{n}^{k} [ 1 ] + Q o {S}_{n}^{k} [ 2 ] * {Weight}_{n}^{k} [ 2 ] \qquad ( {7}^{′} )$$

wherein the respective MCS is selected to maximize the respective STA utility. At action 207 of FIG. 2B, each STA 102 may assess whether the respective MCS has been calculated before the time limit (i.e., the processing time has not exceeded the time limit). If the MCS for a STA 102 has been calculated before the time limit, the STA 102 may send the MCS to the AP 101 as LA parameters, at action 208. If the MCS for a STA 102 has not been calculated before the time limit or if the previous system performance is equal or greater than the respective utility, the STA 102 may send the respective SINR determined at action 203 and respective QoS provisioning LA (QPLA) parameters to the AP 101 as LA parameters, at action 209, so that the AP 101 may calculate the respective MCS. The QPLA parameters may, for example, include DR requirements, PER requirements, and/or PER preferences. STAs 102 that send their respective MCS to the AP 101 may be referred to as collaborative while those that do not may be referred to as non-collaborative.

At action 210 of FIG. 2A, the AP 101 may receive the LA parameters sent from each STA 102. The AP 101 may then inspect, at action 211 of FIG. 2A, the LA parameters from each STA 102 to determine whether they contain a respective MCS. If the LA parameters for a STA 102 do contain the respective MCS, the AP 101 may apply, at action 212 of FIG. 2A, that MCS for respective data transmissions during the kth timeslot. If the LA parameters for a STA 102 lack the respective MCS, the AP 101 may check, at action 213 of FIG. 2A, whether the respective LA parameters contain the respective SINR and QPLA parameters. For all the STAs 102 where the respective LA parameters lack the respective MCS but contain the respective SINR and QPLA parameters, which may amount to N_{NC} STAs 102, the AP 101 may solve the following maximization problem to determine a MCS for those STAs 102, at action 214 of FIG. 2A:

$$2 : {max}_{MCS} {SYS\_U}_{A}^{k} = \frac{1}{{N}_{N C}} {\sum }_{n = 1}^{{N}_{N C}} {\sum }_{j = 1}^{J} Q o {S}_{n}^{k} [ j ] * {Weight}_{n}^{k} [ j ] \qquad ( 8 )$$

$$2 : {max}_{MCS} {SYS\_U}_{A}^{k} = \frac{1}{{N}_{N C}} {\sum }_{n = 1}^{{N}_{N C}} ( Q o {S}_{n}^{k} [ 1 ] * {Weight}_{n}^{k} [ 1 ] + {QoS}_{n}^{k} [ 2 ] * {Weight}_{n}^{k} [ 2 ] ) \qquad ( {8}^{′} )$$

wherein the MCSs are selected to maximize system performance over those same STAs 102.
For all the STAs 102 where the respective LA parameters lack the respective MCS, SINR, and QPLA parameters, the AP 101 may determine a respective MCS through conventional LA optimization, at action 215 of FIG. 2A. Conventional LA optimization may, for example include, solving the following maximization problem:

$$3 : {max}_{MCS} {SYS\_U}_{A}^{k} = \frac{1}{N} {\sum }_{n = 1}^{N} {\sum }_{j = 1}^{J} Q o {S}_{n}^{k} [ j ] * {Weight}_{n}^{k} [ j ] \qquad ( 9 )$$

$$3 : {max}_{MCS} {SYS\_U}_{A}^{k} = \frac{1}{N} {\sum }_{n = 1}^{N} ( Q o {S}_{n}^{k} [ 1 ] * {Weight}_{n}^{k} [ 1 ] + Q o {S}_{n}^{k} [ 2 ] * {Weight}_{n}^{k} [ 2 ] ) \qquad ( {9}^{′} )$$

wherein the MCS is selected to maximize system performance for all N STAs 102. If the AP 101 determines the MCS for a STA 102, it may then apply the MCS for that STA 102 at action 212 of FIG. 2A. Data transmitted, sent or received, in the kth timeslot between the AP 101 and a STA 102 may then be done in accordance with the respective MCS.

A k+1 transmission timeslot may begin following the conclusion of action 212 of FIG. 2A. In the k+1 timeslot, the AP 101 may use the value of SYS_U_{A}^{k} obtained from solving problem [symbol] 2 in the kth timeslot, as defined by Equation 8, for the previous system performance of the k+1 timeslot.

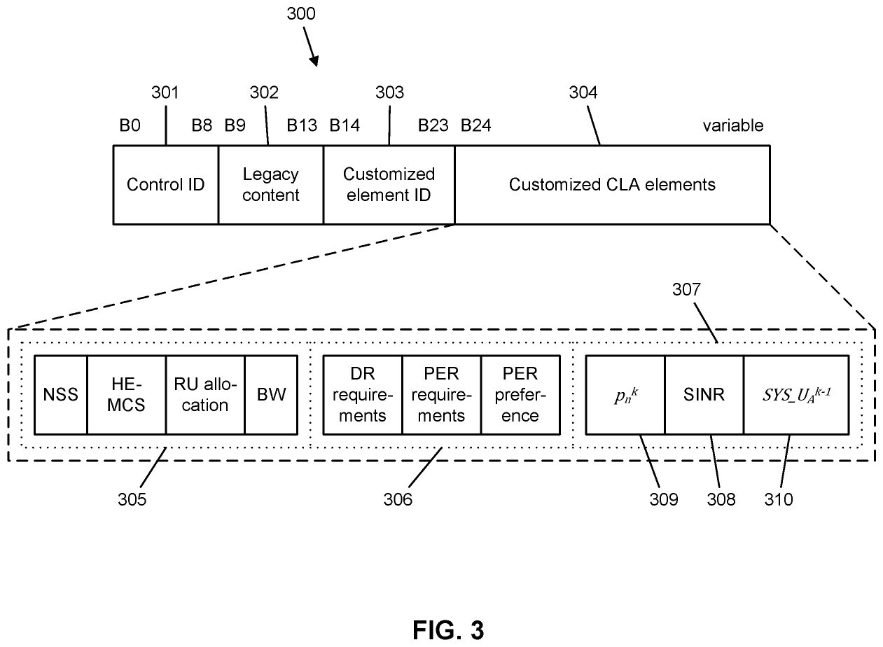

To communicate the collaborative LA information, such as the SINR, power allocation, and previous system performance, between the AP 101 and each STA 102, as described in relation to action 201 of FIG. 2A and action 209 of FIG. 2B for example, the high throughput (HT) control field of a control wrapper frame may be used. The collaborative LA information may alternatively be included, for example, in the high efficiency (HE) control field of a multi-user block-acknowledgement (M-BA) frame, or a data frame. FIG. 3 shows an HT control field 300 for sending the collaborative LA information, in accordance with embodiments of the present disclosure. The HT control field 300 may comprise subfields for a control ID 301 that indicates the respective control mechanism, legacy frame content 302, a customized element identifier (ID) 303, and customized CLA elements 304. The control ID 301 may be unique to collaborative LA. The customized CLA elements 304 may include: conventional LA information 305, such as number spatial stream (NSS), bandwidth (BW), HE-MCS, and RU allocation information; QPLA information 306, such as DR requirements, PER requirements, and PER preferences; and the collaborative LA information 307, such as the SINR 308, power allocation 309, and previous system performance 310. The power allocation and SINR may each be indicated by, for example, eight bits, where the first four bits may be an amplifier and the second four bits may be a base value.

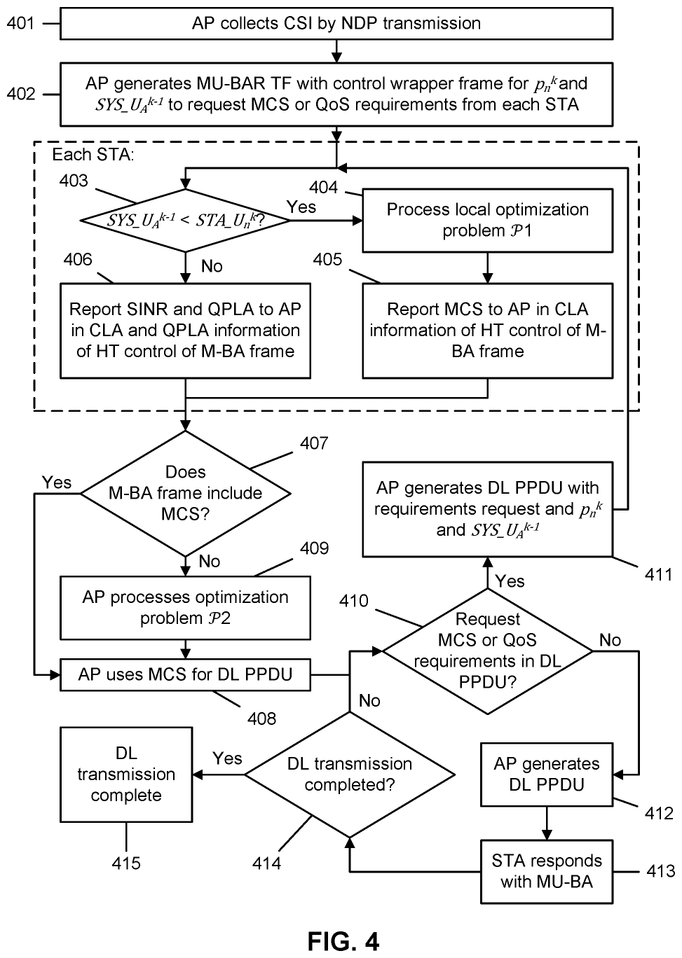

FIG. 4 shows a flowchart for an example implementation of the method of the present disclosure as described in relation to FIG. 2A and FIG. 2B. The example is directed towards multi-user (MU) downlink (DL) data transmission from an AP 101 to multiple STAs 102. At action 401, the AP 101 may collect CSI for the respective link 103 to each STA 102 by sending a non-data packet (NDP) to each STA 102 and gathering the respective CSI from each STA 102. At action 402, for each STA 102, the AP 101 may generate and send a MU block-acknowledgement request (MU-BAR) trigger frame (TF) to request the respective MCS or QoS requirements. The MU-BAR TF may have a control wrapper frame indicating the previous system performance and the respective power allocation for the data transmission. Each STA 102 may then, at action 403, compare the previous system performance to its respective utility, as described in relation to action 204 of FIG. 2B. If the respective utility for a STA 102 is greater than the previous system performance, that STA 102 may locally process the optimization problem [symbol] 1, at action 404, as described in relation to action 206 of FIG. 2B; the same STA 102 may report its respective MCS to the AP 101 in the collaborative LA (CLA) information 307 of the HT control field 300 of a respective MU block-acknowledgement (BA) frame, at action 405. If the respective utility for a STA 102 is less than or equal to the previous system performance, that STA 102 may report its SINR and QPLA parameters to the AP 101 in the CLA information 307 and QPLA information 306 of the HT control field 300 of a respective MU-BA frame, at action 406.

Once the AP 101 receives a MU-BA frame from one of the STAs 102, it may determine, at action 407, whether the MU-BA frame includes the MCS for that STA 102. If the MU-BA frame includes the MCS, the AP 101 may use it, at action 408, towards physical protocol data units (PPDUs) in the DL transmission to that STA 102. If the MU-BA frame does not include the MCS, the AP 101 may, at action 409, process the optimization problem [symbol] 2 to determine the MCS, as described in relation to action 214 of FIG. 2A; the AP 101 may then use this MCS towards action 408.

At action 410, the AP 101 may determine whether it needs to request a new MCS and/or new QoS requirements from each STAs 102 when it sends the PPDU. If the AP 101 decides to request the new MCS and/or new QoS requirements for a STA 102, it will generate, at action 411, the DL PPDU with such a request and include the system performance and respective power allocation; the AP 101 may then send the request to that STA 102, which may initiate action 403 and those following therefrom. Examples of when the AP 101 may decide to request the new MCS and/or new QoS requirements for a STA 102 may include the AP 101 updating the transmission power allocation, the STA 102 has new QoS requirements, or the AP 101 has no reason to believe that the MCS or transmission power allocation for all STAs 102 may not change. If the AP 101 decides not to the request the new MCS and/or new QoS requirements form a STA 102, it will generate, at action 412, the DL PPDU without the request and send it to the STA 102. The STA 102 may then respond, at action 413, with a MU-BA frame.

At action 414, the AP 101 may determine whether the DL transmission is complete. If the transmission is determined to be incomplete, the AP 101 may again determine whether it needs to request a new MCS and/or new QoS requirements from each STA 102 in a next DL PPDU of the transmission, per action 410. If the transmission is determined to be complete, the method may conclude at action 415.

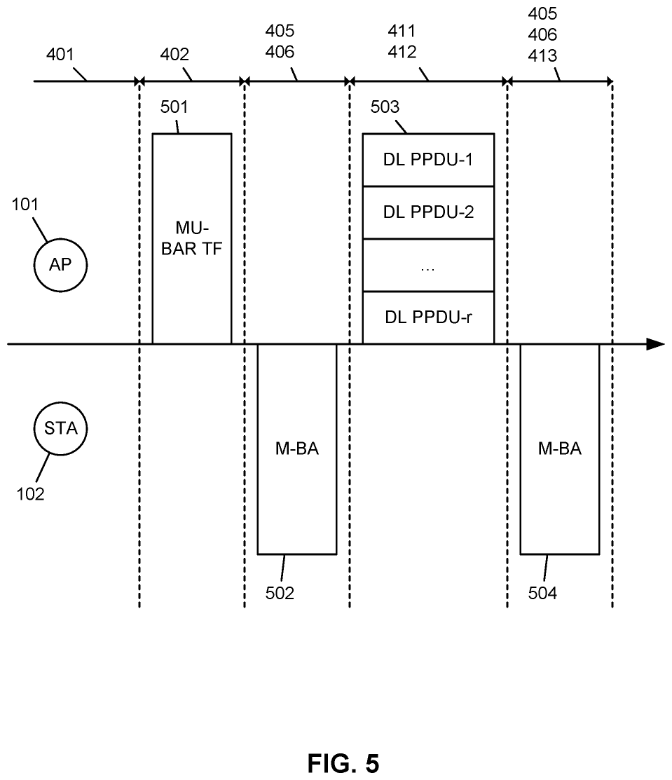

FIG. 5 shows an example of a series of frames being sent between an AP 101 and a STA 102 in accordance with the example implementation of FIG. 4. Following CSI collection of action 401, as discussed in relation to FIG. 4, the AP 101 may send a MU-BAR TF 501 to the STA 102 to request the MCS and/or QoS parameters, as described by action 402 of FIG. 4. The STA 102 may respond with a M-BA 502, which may include the MCS and/or QoS parameters, as described by actions 405 and 406 of FIG. 4. The AP 101 may then send one of a possible series of DL PPDUs 503 for data transmission, as described by actions 411 and 412 of FIG. 4. Each DL PPDU may contain a request for MCS and/or QoS parameters. For each DL PPDU 503 received by the STA 102, it may send a M-BA 502 to the AP 101 to confirm receipt of the DL PPDU 503 and/or to provide a new MCS and/or new QoS parameters, as described by actions 405, 406, and 411 of FIG. 4. The AP 101 may continue to send DL PPDUs 503 to the STA 102 and receive M-BAs in return until the transmission is complete.

An example implementation may comprise the wireless network shown in FIG. 1. In this scenario, the STAs 102 (including a first STA, a second STA, and a third STA) may have the example CLA parameters shown below in Table 1 for a k=1 timeslot. To begin LA, the AP 101 may collect CSI from the STAs 102, as described by action 401 of FIG. 4. The AP 101 may have SYS_Uₙ⁰= 1/15 and may allocate transmission power by an average such that pₙ¹=P/3. The AP 101 may communicate the SYS_U_{A}⁰and pₙ¹ to each STA 102 by a MU-BAR TF 501, as described by action 402 of FIG. 4. Because SYS_U_{A}⁰>STA_U₁¹, the first STA 102, considered as being non-collaborative, may calculate its SINR and send its SINR and QPLA to the AP 101 a M-BA 502, as described by action 406 of FIG. 4. For the second STA 102, SYS_U_{A}⁰>STA_U₂¹, so the second STA 102 is also considered as being non-collaborative; however, the second STA 102 is not capable of determining its QPLA and SINR, so the second STA 102 may send a conventional M-BA 502 lacking this information to the AP 101. For the third STA 102, SYS_U_{A}⁰<STA_U₃¹, so the third STA 102 is considered as being collaborative. The third STA 102 may process the local optimization problem [symbol] 1 and report its MCS in a M-BA 502 to the AP 101, as described by actions 404 and 405 of FIG. 4. The AP 101 may calculate a MCS for the first STA 102 by solving optimization problem [symbol] 2, as described by action 409 of FIG. 4, and may calculate a MCS for the second STA 102 by conventional LA, as described by action 215 of FIG. 2A. The AP 101 may then apply each MCS to respective DL PPDUs 503, as described by action 408 of FIG. 4. In future transmission timeslots, the collaborative status of each STA 102 may change. For example, in a following timeslot, the third STA 102 may receive SYS_U_{A}¹=1 and p₃²=P/3 in a DL PPDU 503 from the AP 101, as described by action 411, and may update STA_C₃² to be 0.1 and STA_T₃¹ to be 1. In this case, SYS_U_{A}¹>STA_U₃², so the third STA 102 may be considered as being non-collaborative.

TABLE 1
Examples of CLA parameters for the STAs 102 of FIG. 1.

| CLA Parameter | First STA | Second STA | Third STA |
|---|---|---|---|
| pₙ¹ | P/3 | P/3 | P/3 |
| STA_Tₙ⁰ | 1 | 0 | 1 |
| STA_Cₙ¹ | 1 | 0 | 0 |
| STA_Uₙ¹ | 0 | 0 | 1 |
| Collaboration | Non-collaborative | Non-collaborative | Collaborative |
| status | | | |
| QPLA and SINR | Available | Not Available | Available |
| availability | | | |

Embodiments of the present disclosure may be implemented using electronics hardware, software, or a combination thereof. In some embodiments, the invention may be implemented by one or multiple computer processors executing program instructions stored in memory. In some embodiments, the invention may be implemented partially or fully in hardware, for example using one or more field programmable gate arrays (FPGAs) or application specific integrated circuits (ASICs) to rapidly perform processing operations.

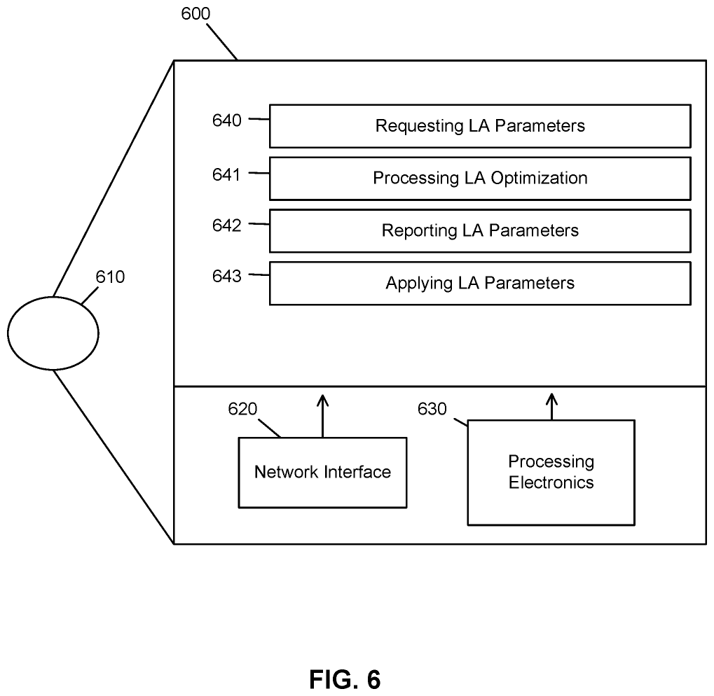

FIG. 6 shows an apparatus 600 for LA in a network, according to embodiments of the present disclosure. The apparatus may be located at a node 610 of the network, such as an AP 101 or a STA 102. The apparatus may include a network interface 620 and processing electronics 630. The processing electronics may include a computer processer executing program instructions stored in memory, or other electronics components such as digital circuitry, including for example FPGAs and ASICs. The network interface may include an optical communication interface or radio communication interface, such as a transmitter and receiver. The apparatus may include several functional components, each of which is partially or fully implemented using the underlying network interface 620 and processing electronics 630. Examples of functional components may include modules for requesting 641 LA parameters, processing 642 LA optimization, reporting 643 LA parameters, and applying 644 LA parameters.

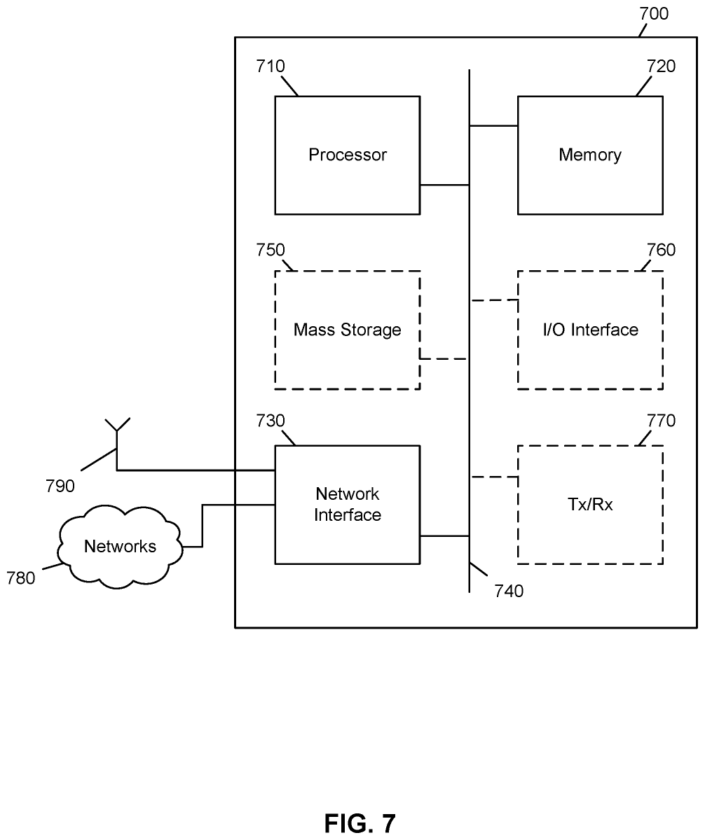

FIG. 7 shows a schematic diagram of an electronic device 700 that may perform any or all of the operations of the above methods and features explicitly or implicitly described herein, according to different embodiments of the present disclosure. For example, a computer equipped with network function may be configured as electronic device 700. The electronic device 700 may be used to implement the apparatus 600 of FIG. 6, for example. The electronic device 700 may further be used as part of an AP controller 104 or a STA controller 105, for example.

As shown, the electronic device 700 may include a processor 710, such as a Central Processing Unit (CPU) or specialized processors such as a Graphics Processing Unit (GPU) or other such processor unit, memory 720, network interface 730, and a bi-directional bus 740 to communicatively couple the components of electronic device 700. Electronic device 700 may also optionally include non-transitory mass storage 750, an I/O interface 760, and a transceiver 770. According to certain embodiments, any or all of the depicted elements may be utilized, or only a subset of the elements. Further, the electronic device 700 may contain multiple instances of certain elements, such as multiple processors, memories, or transceivers. Also, elements of the hardware device may be directly coupled to other elements without the bi-directional bus 740. Additionally or alternatively to a processor and memory, other electronics, such as integrated circuits, may be employed for performing the required logical operations.

The memory 720 may include any type of non-transitory memory such as static random access memory (SRAM), dynamic random access memory (DRAM), synchronous DRAM (SDRAM), read-only memory (ROM), any combination of such, or the like. The mass storage element 750 may include any type of non-transitory storage device, such as a solid-state drive, hard disk drive, a magnetic disk drive, an optical disk drive, USB drive, or any computer program product configured to store data and machine executable program code. According to certain embodiments, the memory 720 or mass storage 750 may have recorded thereon statements and instructions executable by the processor 710 for performing any of the aforementioned method operations described above.

Network interface 730 may include at least one of a wired network interface and a wireless network interface. The network interface 730 may include a wired network interface to connect to a communication network 780 and may also include a radio access network interface 790 for connecting to the communication network 780 or other network elements over a radio link. The network interface 730 enables the electronic device 700 to communicate with remote entities such as those connected to the communication network 780.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include a number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method for link adaption (LA) in a network system including an access point (AP) coupled to one or more stations (STAs) through a respective one or more links,
each STA configured to determine a respective set of optimal link (OL) parameters, each STA having:
a respective STA transmission performance metric characterizing at least one data transmission parameter of the respective STA for the respective link, and
a respective STA utility metric characterizing at least one data processing parameter of the respective STA,
the network system having a system performance metric characterizing an average performance for transmitting data in the network system,
the method comprising, by the AP:
obtaining, from each STA, a respective set of LA parameters, the respective set of LA parameters including, when the respective STA utility metric is greater than the system performance metric, the respective set of OL parameters; and
determining, for each STA from which the respective set of LA parameters lacks the respective set of OL parameters, the respective set of OL parameters.

2. The method of claim 1 further comprising,
by the AP,
for at least one STA of the one or more STAs, in accordance with the respective set of OL parameters, at least one of:
sending data thereto through the respective link, and
receiving data therefrom through the respective link.

3. The method of claim 1 wherein:
each STA further has, for determining the respective set of OL parameters, a respective processing time and a respective time limit; and
the respective set of LA parameters obtained from each STA by the AP includes the respective set of OL parameters when the respective STA utility metric is greater than the system performance metric and when the respective processing time is less than the respective time limit.

4. The method of claim 1 further comprising, by the AP, determining the system performance metric.

5. The method of claim 1 wherein the respective STA transmission performance metric for each STA is defined by a respective STA transmission performance function.

6. The method of claim 5 wherein the system performance metric is defined by a system performance function, the system performance function depending from an average of the respective STA transmission performance function for all STAs of the one or more STAs.

7. The method of claim 5 wherein the system performance metric is defined by a system performance function, the system performance function defined by an average of the respective STA transmission performance function for all STAs from which the respective set of OL parameters lacks the respective set of OL parameters.

8. The method of any one of claim 6 or 7 wherein determining, for each STA from which the respective set of LA parameters lacks the respective set of OL parameters, the respective set of OL parameters includes maximizing the system performance function.

9. The method of claim 5 wherein each STA is configured to determine the respective set of OL parameters by maximizing the respective STA transmission performance function.

10. The method of claim 5 wherein the respective STA transmission performance function of each STA depends from a respective weighted sum of a respective data rate provisioning index and a respective packet error rate provisioning index.

11. The method of claim 10 wherein the respective data rate provisioning index and the respective packet error rate provisioning index each depend from a respective transmission power allocation.

12. The method of claim 1 further comprising,
by the AP:
sending, to each STA, the system performance metric and a respective transmission power allocation.

13. The method of claim 5 wherein the respective STA utility function of each STA is defined by the respective STA transmission performance function and a respective STA cost transformation.

14. The method of claim 1 wherein obtaining, from each STA, the respective set of LA parameters includes obtaining, from each STA of which the LA parameters lacks the respective set of OL parameters, a respective signal-to-interference-plus-noise ratio and one or more respective quality-of-service requirements.

15. The method of claim 1 wherein obtaining, from each STA, the respective set of LA parameters includes obtaining a frame having a high throughput (HT) control field indicating the set of LA parameters.

16. The method of claim 15 wherein, for each STA from which the respective set of LA parameters lacks the respective set of OL parameters, the HT control field has a plurality of subfields indicating a signal-to-interference-plus-noise ratio and one or more respective quality-of-service requirements.

17. The method of claim 12 wherein sending, to each STA, the system performance metric and the respective transmission power allocation includes sending a frame having a high throughput (HT) control field, the HT control field including a plurality of subfields indicating the respective transmission power allocation and the system performance metric.

18. The method of claim 1 further comprising:
by the AP of the network:
applying, for the at least one STA of the one or more STAs, the set of OL parameters to the respective link.

19. The method of claim 1 wherein at least one set of OL parameters includes one of:
a plurality of parameters for a modulation and coding scheme, and
a plurality of parameters for a resource unit allocation.

20. A network system comprising one or more stations (STAs) coupled to an access point (AP) through a respective one or more links,
each STA configured to determine a respective set of optimal link (OL) parameters,
each STA having:
a respective STA transmission performance metric characterizing at least one data transmission parameter of the respective STA for the respective link, and
a respective STA utility metric characterizing at least one data processing parameter of the respective STA,
the network system having a system performance metric characterizing an average performance for transmitting data in the network system,
the AP configured to:
obtain, from each STA, a respective set of link adaptation (LA) parameters, the respective set of LA parameters including, when the respective STA utility metric is greater than the system performance metric, the respective set of OL parameters; and
determine, for each STA from which the respective set of LA parameters lacks the respective set of OL parameters, the respective set of OL parameters.
